(19) United States
(12) Patent Application Publication
(10) Pub. No.: US 2025/0248868 A1
(43) Pub. Date: Aug. 7, 2025

(54) A SYSTEM AND METHOD OF WHEELCHAIR DOCKING

(71) Applicant: Nanyang Technological University, Singapore (SG)

(72) Inventors: Wei Tech ANG, Singapore (SG); Marcus Khee Ing LEONG, Singapore (SG); Neha Priyadarshini GARG, Singapore (SG); Wee Ching PANG, Singapore (SG); Lei LI, Singapore (SG); Manoj RAMANATHAN, Singapore (SG)

(21) Appl. No.: 18/856,163

(22) PCT Filed: Apr. 5, 2023
(86) PCT No.: PCT/SG2023/050229

§ 371 Date: Oct. 11, 2024

(30) Foreign Application Priority Data
Apr. 12, 2022 (SG) 10202203787P

(51) Int. Cl. A61G 5/04; G06T 7/11; G06T 7/13; G06T 7/73

(52) U.S. Cl. CPC A61G 5/04; G06T 7/11; G06T 7/13; G06T 7/74; A61G 2203/22; G06T 2200/24; G06T 2207/10024; G06T 2207/20101; G06T 2207/30252

(57) ABSTRACT

A system and method of docking a wheelchair relative to an object such as a table. The method includes converting a user-selected 2D point in a 2D image of a scene into a 3D point in a 3D point cloud of the scene. A first group of edges is determined from the 3D point cloud based on the 3D point. The method includes defining an intermediate dock pose and an approximated reference edge. The method includes determining a second group of edges from the 3D point cloud and at least one potential reference edge. The method includes determining a dock pose based on one of the at least one potential reference edge and moving the wheelchair towards the dock pose.

### CROSS-REFERENCE TO RELATED APPLICATION

This application claims the benefit of priority to the Singapore Application No. 10202203787P filed Apr. 12, 2022, the contents of which is hereby incorporated by reference in its entirety for all purposes.

### TECHNICAL FIELD

This application relates to a system and method for use with a wheelchair or an assistive mobility device.

### BACKGROUND

There are many daily tasks that involve wheelchair docking operations, e.g., docking the wheelchair at a table at mealtimes, aligning the wheelchair next to a bed in readiness for the user to move from the wheelchair to the bed, navigating the wheelchair into position next to a toilet seat, moving the wheelchair next to a car door, etc. Wheelchair docking can be particularly difficult as there is relatively less space available for any re-orientation of the wheelchair. Many wheelchair users, especially those with upper limb disability, find it challenging to control and maneuver their wheelchairs with sufficient precision in such situations.

### SUMMARY

In one aspect, the present application discloses a method of docking a wheelchair relative to an object. The method includes: converting a user-selected 2D point in a two-dimensional (2D) image of a scene into a three-dimensional (3D) point in a 3D point cloud of the scene. The user-selected 2D point may be de-projected to obtain the 3D point in the point cloud of the scene. Preferably, the object in the 2D image may be segmented to obtain a segmented 2D image, and the 3D point cloud may be filtered to retain a plurality of 3D points corresponding to the object based on the segmented 2D image. The method includes determining a first group of edges from the 3D point cloud based on the 3D point by computing a convex hull of the 3D point cloud, in which the first group of edges includes an approximated reference edge of the object. The method includes defining an intermediate dock pose spaced apart from the approximated reference edge by a spacing. The method includes determining a second group of edges from the 3D point cloud, in which the second group of edges includes at least one potential reference edge. The at least one potential reference edge is based on a plurality of intersections between the second group of edges and respective projection lines between a plurality of random points of the 3D point cloud and the intermediate dock pose. The method includes determining a dock pose based on one of the at least one potential reference edge, and moving the wheelchair towards the dock pose.

In another aspect, the present application discloses a system for wheelchair docking relative to an object. The system comprises: a wheelchair having motorized wheels; an adjustable camera coupled to the wheelchair and adjustable to obtain a view of the scene as viewed from the wheelchair; a user interface configured to receive a user-selected 2D point as an input from a user; and a controller. The controller is coupled to the motorized wheels, and the adjustable camera, and the user interface. The controller is configured to: convert the user-selected 2D point in a two-dimensional (2D) image of the scene into a three-dimensional (3D) point in a 3D point cloud of the scene; determine a first group of edges from the 3D point cloud based on the 3D point, the first group of edges including an approximated reference edge of the object; define an intermediate dock pose spaced apart from the approximated reference edge by a spacing; determine a second group of edges from the 3D point cloud, the second group of edges including at least one potential reference edge, the at least one potential reference edge being based on a plurality of intersections between the second group of edges and respective projection lines between a plurality of random points of the 3D point cloud and the intermediate dock pose; determine a dock pose based on one of the at least one potential reference edge; and control the motorized wheels to move the wheelchair towards the dock pose.

### BRIEF DESCRIPTION OF THE DRAWINGS

Various embodiments of the present disclosure are described below with reference to the following drawings:

FIG. 1 is a schematic flowchart illustrating a method of wheelchair docking according to an embodiment of the present disclosure;

FIG. 2 is a schematic block diagram of one embodiment of a system configured to perform the method of FIG. 1;

FIG. 3A is an exemplary 2D RGB image of a scene presented to a user;

FIG. 3B is the 2D RGB image of FIG. 3A after segmentation;

FIG. 4 is a corresponding 3D point cloud of the scene of FIG. 3A;

FIG. 5 is the 3D point cloud of FIG. 4 illustrating a 3D point (Pᵤ) and a de-projection line;

FIG. 6 is the 3D point cloud of FIG. 4 illustrating an intermediate dock pose (χ_{itmd});

FIG. 7 is a schematic drawing of a top view of a scene illustrating a first group of points and edges of a 3D point cloud in an example involving wheelchair docking at a table;

FIG. 8 is schematic drawing of the scene of FIG. 7 illustrating a second group of points and edges of the 3D point cloud;

FIG. 9 is a schematic drawing of the scene of FIG. 7 illustrating multiple random points of the 3D point cloud;

FIG. 10 is a schematic drawing of the scene of FIG. 7 illustrating multiple potential reference edges of the table;

FIG. 11 is a schematic drawing of the top view of a scene illustrating multiple random points of a 3D point cloud for a table, according to another example;

FIG. 12 is a schematic drawing of the scene of FIG. 11 illustrating multiple potential reference edges of the table;

FIG. 13 is a schematic drawing of the scene of FIG. 11 illustrating fitting models to the table;

FIG. 14 is a schematic drawing of the scene of FIG. 11 illustrating the dock pose relative to the table;

FIG. 15 is a schematic drawing of the scene of FIG. 11 illustrating a footprint of the wheelchair and multiple search poses;

FIG. 16 is a schematic drawing of a top view of a scene illustrating a footprint of the wheelchair and multiple search poses in an example with a round table;

FIG. 17A is an exemplary image of a 3D point cloud illustrating a final dock pose during motion planning;

FIG. 17B is a schematic line drawing representing FIG. 17A from which the image of the 3D point cloud has been omitted to avoid obfuscation;

FIGS. 18A to 18C are images of a white glossy table placed close to a wall in experiments;

FIGS. 19A and 19B are 2D images with 10% and 40% of the table visible respectively;

FIG. 20 shows images of different scenarios (Scenario One, Scenario Two, and Scenario Three) tested in experiments;

FIG. 21 is a bar chart comparing an Average Score from a NASA-TLX survey and a Performance Score of an example of the present method against a baseline (* indicates that a lower score is better, \hat{ } indicates that a higher score is better);

FIG. 22 is a bar chart comparing an Average Score for Perceived Usefulness and a Perceived Ease-of-Use (lower is better) of the present method against the baseline;

FIG. 23 is a bar chart showing results of user preferences; and

FIGS. 24 and 25 are respective sets of images showing the effect of segmentation with the top row showing the process on a big table and the bottom row showing the process on a small table.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance as generally understood in the relevant technical field, e.g., within 10% of the specified value.

As used herein, the term “and/or” includes any and all combinations of one or more of the associated listed items.

As used herein, “comprising” means including, but not limited to, whatever follows the word “comprising”. Thus, use of the term “comprising” indicates that the listed elements are required or mandatory, but that other elements are optional and may or may not be present.

As used herein, “consisting of” means including, and limited to, whatever follows the phrase “consisting of”. Thus, use of the phrase “consisting of” indicates that the listed elements are required or mandatory, and that no other elements may be present.

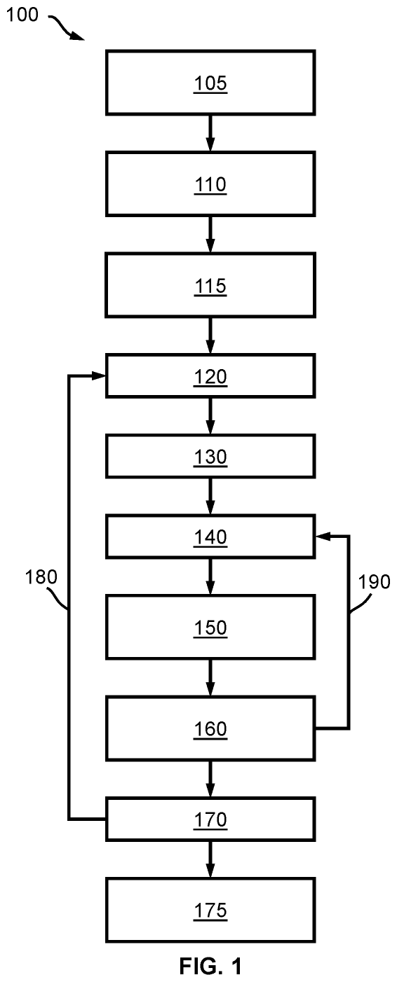

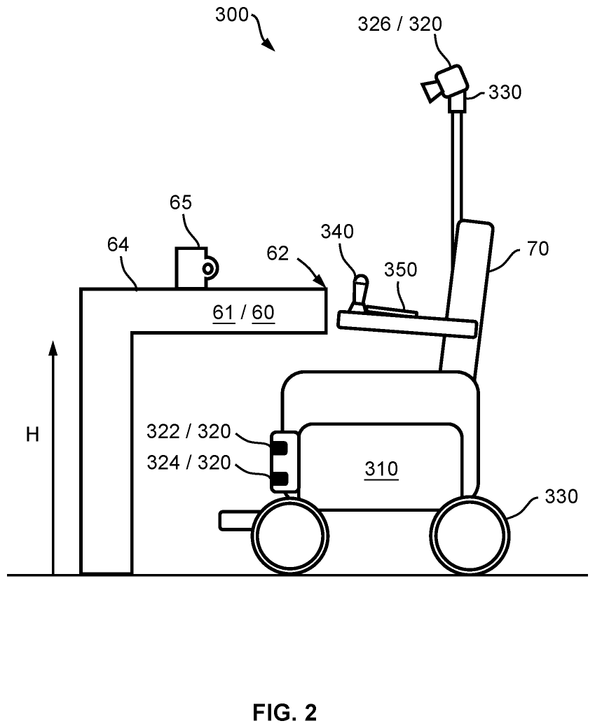

A detailed description of various examples will be described below with reference to FIG. 1 and FIG. 2. FIG. 1 is a schematic flowchart illustrating an example of a method 100 of wheelchair docking. FIG. 2 is a schematic diagram showing a system 300 configured to perform the method 100 according to one embodiment of the present disclosure.

The term “wheelchair” as used herein is to be understood to include but not be limited to a motorized wheelchair, robotic wheelchair, or assistive mobility device. The wheelchair 70 may include a joystick 340 intended for manipulation by a user so as to provide user control (manual control) of a movement of the wheelchair 70 and/or a direction of movement of the wheelchair 70. The system 300 may include a controller 310 configured to control autonomous movement of the wheelchair 70 and/or the direction of the movement of the wheelchair 70. The controller 310 may be disposed on the wheelchair 70 or elsewhere. In the experiments conducted, a prototype of the proposed system 300 included a programmable controller 310 and a plurality of sensors 320 disposed on the wheelchair 70 and configured for signal communication with one another in operation. In the non-limiting example illustrated, the one or more sensors 320 include at least one camera 322 and at least one range sensor 324 disposed on either side of the wheelchair 70, generally oriented to detect or sense the physical environment frontward and/or to either side of the wheelchair 70. The one or more sensors 320 further include an adjustable camera 326 coupled to the wheelchair 70, preferably around or above the head of the user seated in the wheelchair. The adjustable camera 326 is generally oriented to acquire images as viewed by the user seated in the wheelchair 70 or to provide a generally frontward view of the wheelchair 70. The adjustable camera 326 may be coupled to an actuator and/or motor 330 such that the adjustable camera 326 may rotate relative to the wheelchair 70 and capture a wider range of view or different views of the scene, similar to a person turning his/her head to obtain a wider range of view of the scene ahead. The wheelchair 70 may include one or more actuators or motors, which are in turn coupled to a set of wheels 330 to drive a movement of wheelchair 70.

As used herein, the terms “docking”, “wheelchair docking”, and “table docking” may be used interchangeably, and refer to bringing the wheelchair to a destination at/beside/in alignment with an object, in a predefined orientation relative to the object. Examples of the object include but are not limited to a table or other articles of furniture, vehicles, building elements, etc. The “docking” as described herein goes beyond the docking of an AGV (autonomous guided vehicle) found, for example, in a warehouse or in the case of a floor cleaning robot. The docking of the AGV takes place at a specially designated charging station customized to receive the AGV into a docked position. In contrast, it is a common problem that wheelchair users have difficulties using facilities not specially designed for use with a wheelchair. Understandably, to the user seated in a wheelchair, it is important to be able to carry out docking operations anywhere, e.g., at any table without requiring the table to be customized for the particular wheelchair. As used herein, the term “docking position” is not limited to a position at a customized docking station.

The terms “docking pose” or “dock pose” are used interchangeably herein to refer to a position and orientation of the wheelchair when the wheelchair is stopped at/beside/in alignment with the object or in relation to the object, in which examples of the object include but are not limited to a table. The terms as used herein may each include a position in a space (e.g., an X-Y-Z coordinate in a Cartesian coordinate system. The terms as used herein may also include an orientation, e.g., a direction or a facing of the dock pose. A skilled person in the technical field will understand the challenges in docking a wheelchair over bringing a wheelchair to a stop. Bringing a wheelchair to a stop refers to having the wheelchair stop in a particular place in any orientation. “Docking” refers to enabling the wheelchair to stop nearby in a perpendicular or parallel orientation with respect to the object of interest.

### 2D Image-Based User Input

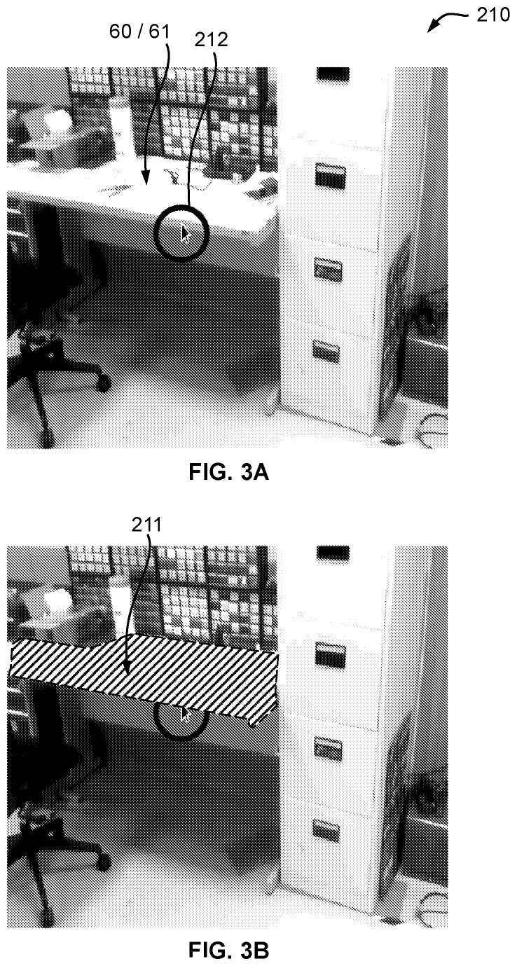

Referring again to FIG. 1, the method 100 may include the system 300 presenting a 2D (two-dimensional) image via a user interface 350 to the user and receiving an input from the user, in which the input includes the user's selection of a 2D point on the 2D image (step 105). The user may be the person seated in the wheelchair. In some situations, the user-selected 2D point may be selected by a care giver of the person seated in the wheelchair. The 2D image is preferably an RGB image of the scene before the user or a 2D graphical rendition of the scene as viewed from the user's perspective or from the wheelchair's perspective. One non-limiting example of the 2D image 210 is shown in the image of a scene in FIG. 3A. The 2D image 210 may be an RGB image captured by the adjustable camera 326. The 2D image 210 is preferably a still image in a format such that an untrained user can pick out a 2D point (pixel) to indicate the user's preferred docking position 212 relative to an object 60. The set of points available for selection by the user includes the plurality of points in a visible surface 64 in the 2D image of the scene, as viewed from the wheelchair 70 and without data on the depth of the object visible in the image. The 2D image presented to the user need not include a complete view of the preferred docking position (in this case, at the table) and/or potential obstacles (e.g., the chair). When shown a 2D image 210 of the scene including at least a partial view of the desired docking position, the user may select a 2D point by pointing to an edge 62 or to a visible surface 64 of the object 60 in the image 210, and this 2D point will be used as user input (i.e., the user-selected 2D point). For a user with limited skill or ability to precisely control the selection of a point, the system 300 is configured to receive user input in the form of a 2D point on the at least partially visible surface 64 of the object 60. In the present disclosure, reference to a table 61 in the following will be understood as a non-limiting example of the object 60 relative to which the docking position is determined by the present system 300 and method 100 of wheelchair docking.

The selected 2D point is referred to herein as a user-selected 2D point as the user is free to select the place where the wheelchair 70 should preferably be docked. This initial user-selected 2D point acquired by the system 300 is wholly based on a user selection of a point (one 2D point) from a 2D image 210 of the scene as viewed from the wheelchair or as viewed by the user, i.e., it is wholly based on one user-selected 2D point. The system 300 does not pre-calculate candidate docking positions and the user is not given a list of calculated or predicted candidate docking positions to select from. That is, the user-selected 2D point is not one selected by the user from a list of candidate docking positions.

Counter-intuitively, in embodiments of the present disclosure, the user is provided with a 2D image at the beginning of the docking operation. In the preferred method, once the 2D point has been selected (i.e., once a user-selected 2D point is acquired by the system 300), the user does not need to manually provide further input or manually control the wheelchair for moving and/or re-orientating the wheelchair for the purpose of docking. Intuitively, one would expect 3D images to give a more complete picture (including the depth data), however, in the present method 100, the user input to the system 300 does not include 3D point or depth data.

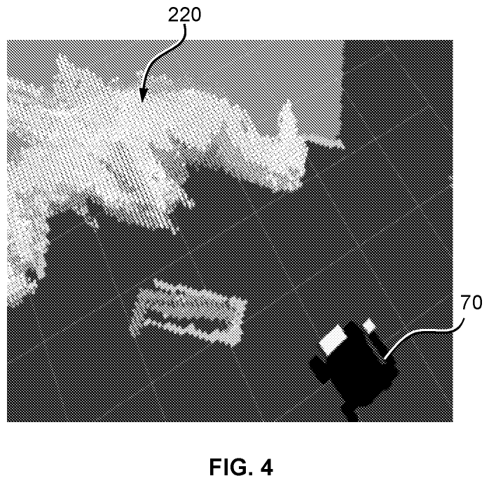

FIG. 4 is an image of a 3D point cloud 220 corresponding to the scene shown in the 2D image of FIG. 3A. The location and pose of the wheelchair 70 may also be included in the 3D point cloud image. To an untrained user, it can be difficult to recognize the actual objects (e.g., a table, a cabinet, a partial view of a chair) in the point cloud image of FIG. 4. The method includes converting the user-selected 2D point 212 into a 3D (three-dimensional) point 222 in a 3D point cloud of the scene (e.g., step 110 of FIG. 1). As used herein, the 2D image does not include data on the depth.

### Segmentation

In some embodiments as illustrated in FIG. 3B, the method 100 includes segmenting the 2D image to obtain a segmented 2D image 211. The method 100 may further include filtering the 3D point cloud obtained from the segmented 2D image to retain a plurality of 3D points, in which the retained 3D points correspond to the object 60 as viewed in the 2D image. That is, the plurality of 3D points retained correspond to the object 60 based on the segmented 2D image. Various segmentation methods may be used. In some experiments, a ViT (vision transformer) was used to obtain a segmented 2D image of the object 60 and to retain relevant 3D points in the 3D point cloud (e.g., step 115 of FIG. 1).

### Dock Pose

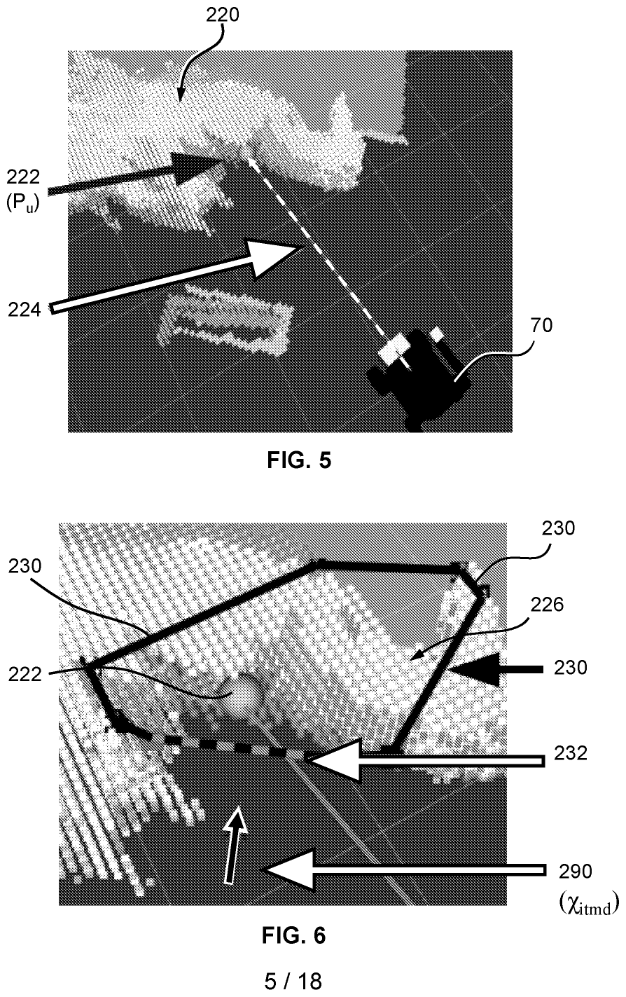

After obtaining the 3D point cloud, the method 100 determines a dock pose for the wheelchair 70. The method 100 includes determining a first group of edges (e.g., 120 of FIG. 1) of the table 61 based on the 3D point cloud. Based on first group of edges, an intermediate dock pose is determined (e.g., 130 of FIG. 1). Referring to FIG. 5, for purpose of determining a dock pose (χ_{dock}) for the wheelchair 70, the user-selected 2D point 212 on the 2D RGB image 210 of a scene is converted to a 3D point (Pᵤ) 222 in the 3D point cloud 220. The user-selected 2D point 212 may be adjacent to the object 60 in the 2D RGB image 210. In one embodiment, the conversion of the user-selected 2D point 212 on the 2D RGB image 210 to the 3D point 222 in the 3D point cloud 220 is by way of de-projecting the pixels using sensor or camera parameters. A de-projection line 224 may be constructed from the camera 120 as shown in FIG. 5. The 3D point (Pᵤ) 222 corresponding to the user-selected 2D point 212 may lie at any depth along the de-projection line 224. As an example, for computing a depth of the 3D point (Pᵤ) 222, a depth of an intersection of the de-projection line 224 with the 3D point cloud 220 of the scene may be used as the depth the 3D point (Pᵤ) 222.

The present method 100 advantageously determines the depth of the 3D point (Pᵤ) 222 based on accumulating point clouds from multiple time instants, instead of relying on the point cloud at only one time instant. In one embodiment, the 3D point cloud is preferably accumulated by use of a spatio-temporal voxel layer. The spatio-temporal voxel layer may accumulate point clouds from multiple time steps (time instants) and from multiple cameras 320 (such as two RGB-Depth cameras). The points which are not present in the multiple acquired 3D point clouds may be slowly decayed with only the persistent points being accumulated. It may be appreciated that the de-projection line 224 may intersect with many points in the spatio-temporal voxel layer.

In one example, the present method 100 is configured to choose the intersection point between the de-projection line 224 and the spatio-temporal voxel layer as a point most likely to lie adjacent to or at the edge 62 (FIG. 2) closest to the adjustable camera 326. FIG. 5 illustrates a sample 3D point (Pᵤ) 222 based on the intersection between the de-projection line 224 and the spatio-temporal voxel layer. While spatio-temporal voxel layer method described here has the advantage of being less noisy, it may be appreciated that other forms of 3D point cloud accumulation methods may also be viable and operable options.

The system 100 is configured to determine (compute) a dock pose (χ_{dock}) which is perpendicular to an edge of the table 60 that is closest to the 3D point (Pᵤ) 222. While the user is likely to select a 2D point close to the edge 62 to indicate the user-selected 2D point, there may be some situations where the corresponding 3D point (Pᵤ) 222 is not at the edge 62, but instead be on the visible surface 64 (FIG. 2) of the table 61 or on some article 65 (FIG. 2) disposed on the table 61.

It is not trivial to determine one or more edges of the table 60 from the 3D point cloud, especially if there are other objects like chairs close to the table 60 or when the table 60 is partially occluded. The following describes the steps to determine a dock pose (χ_{dock}) from the 3D point (Pᵤ) 222, according to embodiments of the present disclosure.

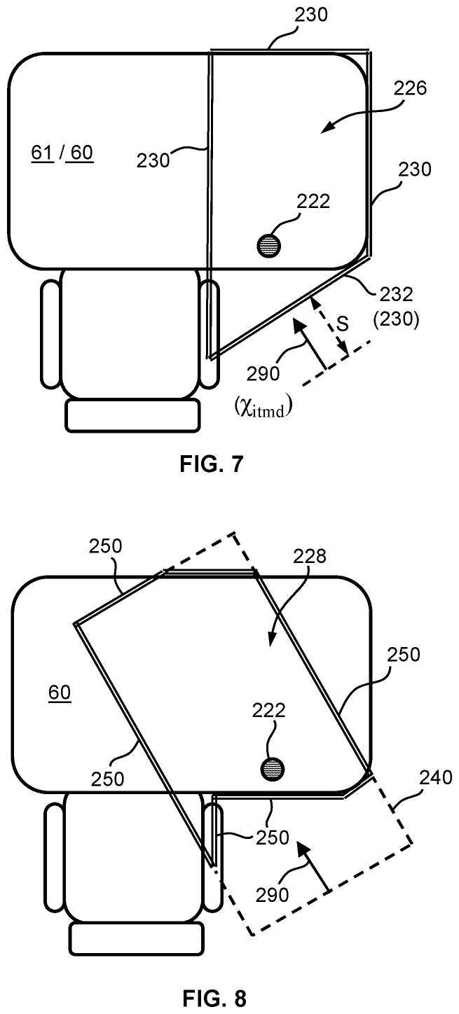

FIG. 6 illustrates a subsequent step of determining an intermediate dock pose (χ_{itmd}) 290 based on the 3D point cloud of FIG. 5 (e.g., step 130 of FIG. 1). To aid understanding, reference is also made to FIG. 7 which provides a schematic diagram of a top view of a 3D point cloud 230 relative to a table 61, according to one example. Upon converting the user-selected 2D point 212 on the 2D RGB image 210 to a 3D point (Pᵤ) 222 in the 3D point cloud 220, for purpose of determining the dock pose (χ_{dock}), the system 100 first determines an intermediate dock pose (χ_{itmd}) 290. The system 300 is configured to determine a first group of points 226 surrounding the 3D point (Pᵤ) 222, based on the assumption that the reference edge or the edge 62 of the table 61 closest to the 3D point (Pᵤ) 222 would lie in an adjacent region around the 3D point (Pᵤ) 222. If applicable, the first group of points 226 within a predetermined range of height (H) values, e.g., from about 0.75 meters (m) to about 1.2 m for a table, are computed around the 3D point (Pᵤ) 222. The first group of points 226 may correspond to a first group of edges 230 surrounding the 3D point (Pᵤ) 222. In some embodiments, the first group of points 226 may be a convex hull of the 3D point cloud 220 around the 3D point (Pᵤ) 222 within the predetermined range of height (H) values, wherein edges 230 of the convex hull surround the 3D point (Pᵤ) 222. In other words, the method 100 includes computing a convex hull 230 of the points around the 3D point cloud 226 and around the 3D point (Pᵤ) 222, and using the edge of the convex hull closest to the 3D point (Pᵤ) as an approximate reference edge 232. The approximate reference edge 232 may be a first approximation of the edge of the object 60.

That is, the system 300 is configured to select the approximated reference edge 232 from the first group of edges 230 or from the edges 230 of the convex hull closest to the 3D point (Pᵤ) 222. The approximated reference edge 232 may be determined as the edge that the user wants to dock to. Based on the approximated reference edge 232, the system 300 determines an intermediate dock pose (χ_{itmd}) 290 by projecting 3D point (Pᵤ) 222 onto the approximated reference edge 232 and moving the projected point outwards (away from the table 61 and towards the wheelchair 70) such that the projected point is spaced apart from the approximated reference edge 232. As an example, the intermediate dock pose (χ_{itmd}) 290 may be spaced apart from the approximated reference edge 232 by a spacing(S) of about 0.5 m. Determining an intermediate dock pose (χ_{itmd}) prior to determining the dock pose (χ_{dock}) is found to be advantageous. It helps to ensure that the intermediate dock pose (χ_{itmd}) 290 is not within the table 61. It also helps in cases where the convex hull of points may have included points that do not belong to the table 61. Because the system 300 and the method 100 is able to address these and other potential errors, the user may have the ease and freedom of providing user input of the user-selected 2D point based on a 2D RGB image of the scene in which the object 60 may be no more than partially visible.

The system 300 is configured to exclude points from other articles and/or obstacles, such as points from the chair beside the user-selected 2D point. These points are excluded from the points around the 3D point (Pᵤ) 222 before the edge 62 of the table 61 is determined by the system 300. It is found that this contributes to reliability of the system 300 in the determination of the dock pose (χ_{dock}) based on the intermediate dock pose (χ_{itmd}).

Referring now to FIG. 8, the method 100 includes further processing the 3D point cloud 220 to determine the dock pose (χ_{dock}). To recap, the intermediate dock pose (χ_{itmd}) 290 is located outside of the table 60 and spaced apart from the approximated reference edge 232. The points in front of the intermediate dock pose (χ_{itmd}) 290 (the points between the intermediate dock pose and the table 61) include points close to the edge 61 corresponding to the user-selected 2D point. The system 300 is configured to extract the table edge from the 3D point cloud 220, by first obtaining a sampled region 240 in front of the intermediate dock pose (χ_{itmd}) 290. In other words, the sampled region 240 is selected such that the intermediate dock pose (χ_{itmd}) 290 faces the sampled region 240. A second group of points 228 from the 3D point cloud 220 is determined within the sampled region 240 (e.g., 140 of FIG. 1). The second group of points 228 may correspond to a second group of edges 250 surrounding the second group of points 228. The intermediate dock pose (χ_{itmd}) 290 also faces the second group of edges 250. In some embodiments, the second group of points 228 may be a concave hull of the 3D point cloud 220 within the sampled region 240, wherein the intermediate dock pose (χ_{itmd}) 290 faces the edges 250 of the concave hull of the 3D point cloud 220 within the sampled region 240.

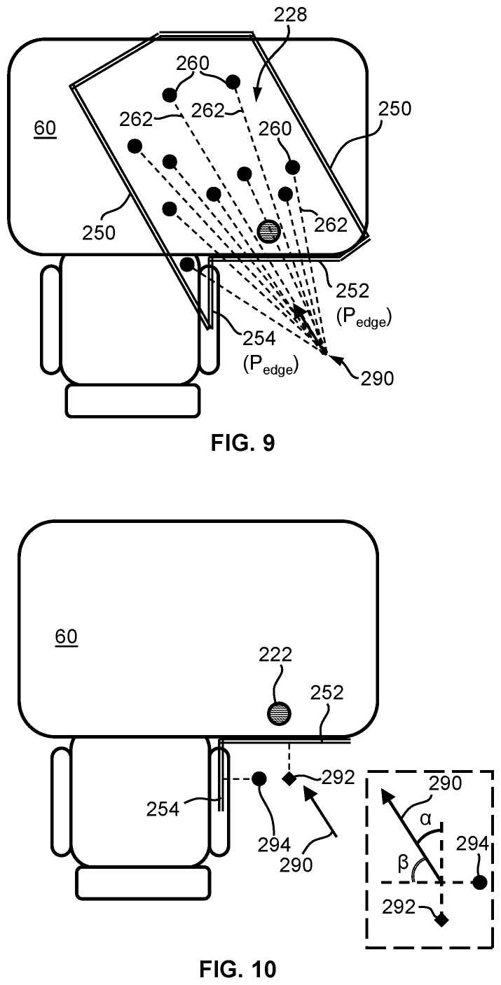

According to the present method 100, determining the reference edge or edge 62 of the table 61 involves first determining one or more potential reference edges (P_{edges}) based on the second group of edges 250 or from the edges 250 of the concave hull (e.g., step 150 of FIG. 1). Making reference to FIG. 9, the system 300 is configured to sample a number of random points 260 of the 3D point cloud from within the second group of edges 250 or the edges 250 of the concave hull. In other words, the second group of edges 250 surrounds the random points 260. In some embodiments, the number of random points 260 may be predetermined according to parameters of the docking system 100, such as the number of sensors 120, the resolution of the sensors 120, the iteration rate of the controller 310, etc. In an example as illustrated in FIG. 9, ten points 260 were sampled from within the edges 250 of the concave hull. Respective projection lines 262 joining each of the random points 260 with the intermediate dock pose (χ_{itmd}) 290 are defined by the system 300. When one or more intersection(s) is formed between the projection lines 262 and the second group of edges 250 or the edges 250 of the concave hull, the respective edges are determined as potential reference edges (P_{edge}) 252/254. In other words, the potential reference edges (P_{edge}) 252/254 intersect at least one of the projection lines 262. In the example of FIG. 9 there are two potential reference edges (P_{edge}) 252/254.

Referring now to FIG. 10, in order to remove potential reference edges (P_{edge}) 252 which does not belong to the table 61, perpendicular poses 292/294 spaced apart from each of the potential reference edges (P_{edge}) 252/254 are defined by the system 300. Perpendicular poses that are not within an angular range relative to the intermediate dock pose (χ_{itmd}) 290 are deemed unlikely to belong to the actual edges of the table 61 and are rejected or discarded. Perpendicular poses that are within the angular range relative to the intermediate dock pose (χ_{itmd}) 290 are selected as potential reference edges (P_{edge}). In some embodiments, the angular range may be predetermined and preferably be within a threshold angle (@edges) such as (but not limited to) a range from 25 degrees to 65 degrees, or preferably within 45 degrees. As the intermediate dock pose (χ_{itmd}) 290 is approximated using the convex hull of the 3D point cloud 220, the perpendicular poses which are not within 45 degrees (@edges) of the intermediate dock pose (χ_{itmd}) 290 may be considered unlikely to belong to the edge 62 of the table 61 or to the reference edge. The system 300 is configured to filter out or discard potential reference edges (P_{edge}) that do not belong to the table 61, based on determining a respective perpendicular pose for each of the potential reference edges (P_{edge}).

Referring to FIG. 10 as an example, the perpendicular pose 294 forms an angle β with the intermediate dock pose (χ_{itmd}) 290 in which the angle β is larger than the angular range of 45 degrees. The system 300 is configured to discard the corresponding edge as a potential reference edge (P_{edge}) 254. In the case of the perpendicular pose 292 which forms an angle α with the intermediate dock pose (χ_{itmd}) 290 where the angle α is within the angular range of 45 degrees, the system 300 is configured to select the corresponding edge as a potential reference edge (P_{edge}). In some embodiments, there may be more than one potential reference edges (P_{edge}) selected by the system 300.

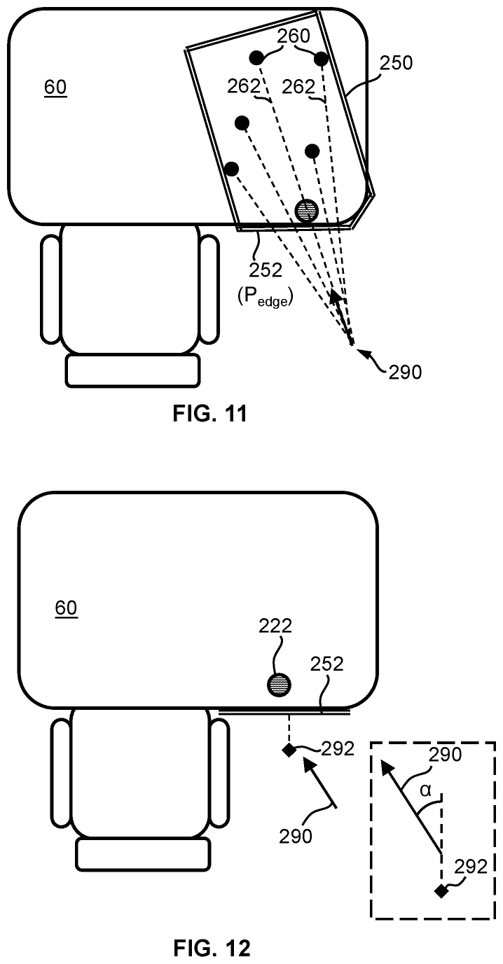

In another example as illustrated in FIGS. 11 and 12, depending on parameters such as a position of the user-selected 2D point, fewer random points may be sampled from within the edges 250 of the concave hull. In the example illustrate five points 260 were selected. In this example, only one potential reference edge (P_{edge}) 252 is determined by the system 300, in which the angle of the potential reference edge (P_{edge}) 252 relative to the intermediate dock pose (χ_{itmd}) 290 is within the threshold angle (e.g., angular range of about 45 degrees). Therefore, no potential reference edges (P_{edge}) are discarded. In some embodiments, there may be multiple potential reference edge (P_{edge}) determined with none of the potential reference edges (P_{edge}) discarded.

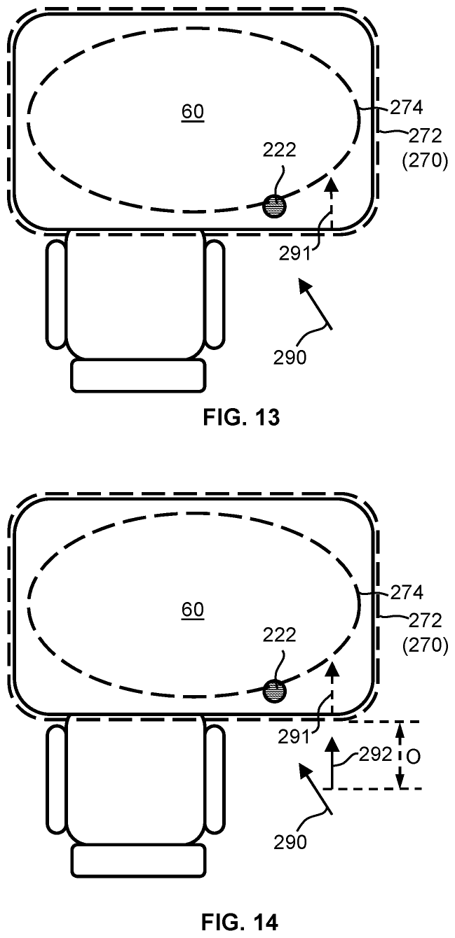

Referring now to FIGS. 13 and 14 and to step 160 of FIG. 1, one or more geometric model 270, such as a quadrilateral (rectangle) model 272 or circular (round) model 274, may be fitted to the points on the selected potential reference edges (P_{edge}) 252 to obtain an estimate of the edge(s) of the table 61. The system 300 may be configured to use Random Sample Consensus (RANSAC) model, for example. The geometric model 272 which provides a closer fit with the edges of the table 61 is chosen. A dock pose (χ_{dock}) 292 may then be determined by projecting the intermediate dock pose (χ_{itmd}) 290 onto the chosen geometric model 272 (or corresponding edge 62) to obtain a projection 291 and by adding an offset (O) to the projection 291. In some embodiments, the projection 291 may be perpendicular to the fitted geometric model 272. In an example suitable for a wheelchair and table scenario, the offset (O) may be set at about 0.2 m. It may be appreciated that the offset (O) may be predetermined based on different application scenarios, such as wheelchair docking to a table, a bed, a car door/car seat, etc.

The system 300 may be further configured to take into consideration various geometric characteristics of various objects 60. For example, if the object 60 is a table 61, the user may prefer to sit with the upper body relatively close to the edge 62 to facilitate the user's use of the table 61. The dock pose thus preferably provides for the lower body of the user (seated on the wheelchair) to be “slotted” under the table top although the wheelchair may appear to “collide” with the table 61. The present system 300 is configured to handle such variations.

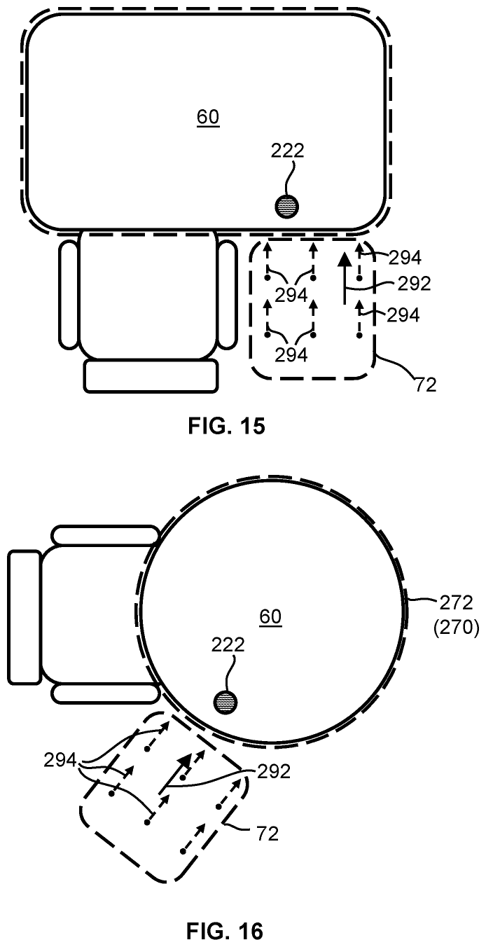

Referring now to FIG. 15, to ensure that the dock pose (χ_{dock}) 292 is not in collision with the table 61 (for example), the system 300 may be configured to define a footprint 72 of the wheelchair 70 at the dock pose (χ_{dock}) 292, with the sum of a local costmap grid cells calculated to be within the footprint 72. The footprint 72 may correspond to a maximum dimension of the wheelchair 70, such as a polygonal cross section corresponding to the size of the wheelchair 70. In some examples, such as the one shown in FIG. 15, the footprint 72 may simply be a rectangular cross section. A higher cost is indicative of a higher chance of collision. The system 300 may be configured to search around the dock pose (χ_{dock}) 292 for other possible dock poses (or search poses 294) in response to the cost being higher than a threshold. In one non-limiting example, the threshold may be set at 0.5. In some embodiments, the search poses 294 are restricted based on in-liers of a RANSAC model and the search pose 294 closest to the initially determined dock pose (χ_{dock}) 292 will be used as the new dock pose (χ_{dock}) 292. In other words, the system 300 is configured such that, responsive to a sum of cost within a footprint of the wheelchair exceeding a threshold, the system 300 determines a (new) dock pose (χ_{dock}) 292 from the search poses 294. In another embodiment as illustrated in FIG. 16, the geometric model 270 may be a circular model or round model.

In some embodiments, the method 100 may include iteratively and/or periodically updating the dock pose (χ_{dock}) 292 with more 3D point cloud accumulation. That is, the method 100 may include iteratively updating the 3D point cloud based on a plurality of 2D images acquired at various time instants concurrently with the moving of the wheelchair. In some embodiments, as shown in Table 1 (Algorithm 1), updating the dock pose (χ_{dock}) 292 includes using the most updated spatio-temporal voxel layer of the 3D point cloud, repeating the process as illustrated in FIGS. 8 to 15 (e.g., 190 of FIG. 1), determining the potential reference edges (P_{edges}) 252 from the second group of edges 250, removing potential reference edges (P_{edge}) 252 which does not belong to the table 60 (if any), and fitting a geometric model 272 to the potential reference edges (P_{edge}) 252 (e.g., 160 of FIG. 1). This is followed by determining an updated dock pose (χ_{dock}) 292 from the search poses 294 responsive to a sum of cost within a footprint of the wheelchair 70 exceeding a threshold.

TABLE 1
Algorithm 1 to update a dock pose.

| Input: | Time step, T, Accumulated Table Edges, P_{edges} , Local Costmap, M_{local} , | | | | | |
|---|---|---|---|---|---|---|
| | Intermediate Dock Pose, χ_{itmd} | | | | | |
| Output: | Updated Docking Goal Pose, χ_{dock} | | | | | |
| 1: | procedure UPDATEPOSE(T, P_{edges}, M_{local}, χ_{itmd}) | | | | | |
| 2: | | while True do | | | | |
| 3: | | | L ← SpatioTemporalVoxelLayer(T) | | | |
| 4: | | | H_{concave} ← GetConcaveHull(L) | | | |
| 5: | | | | | | |
| 6: | | | P′_{edges} ← GetTargetEdges(H_{concave}, χ_{itmd}) | | | See FIG. 8 |
| 7: | | | | | | |
| 8: | | | append P′_{edges} to P_{edges} | | | See FIG. 9 |
| 9: | | | Rₘ ← FitModel(P_{edges}) | | | |
| 10: | | | if Check ModelFit (Rₘ, P_{edges}) then | | | |
| 11: | | | | χ′_{dock} ← ProjectPoseToModel(χ_{itmd}, Rₘ) | | |
| 12: | | | | | | |
| 13: | | | | if not PoseReachable(χ′_{dock}, M_{local}) then | | See FIG. 14 |
| 14: | | | | | χ′_{dock} ← SearchPose (χ_{itmd}, Rₘ, M_{local}) | |

| 15: | | |
|---|---|---|
| 16: | end if | See FIGS. 15 |
| | | and 16 |
| 17: | χ_{dock} ← χ′_{dock} | |
| 18: | clear P_{edges} | |

| | |
|---|---|
| 19: | end if |

| | |
|---|---|
| 20: | end while |

The updating of the dock pose (χ_{dock}) 292 may be performed periodically, for example every 0.5 seconds, with the latest spatio-temporal voxel layer of the 3D point cloud. It may be appreciated that the frequency of updating the dock pose (χ_{dock}) 292 may be the same as (in phase with) the frequency of updating the spatio-temporal voxel layer of the 3D point cloud. In some embodiments, the frequency of updating the dock pose (χ_{dock}) 292 may be different or lower from the frequency of updating the spatio-temporal voxel layer of the 3D point cloud, to allow an accumulation of points in the spatio-temporal voxel layer prior to updating the dock pose (χ_{dock}) 292.

For situations where the RANSAC is not able to get a good fit to a geometric model 270, the potential reference edges (P_{edge}) 252 may be computed from the concave hulls from previous time instants, and the potential reference edges may be accumulated until a line model (quadrilateral model) or a round model (circular model) can be fitted to the potential reference edges (P_{edge}) 252. When the RANSAC is able to fit a line model or a round model, the dock pose (χ_{dock}) 292 is updated by projecting the intermediate dock pose (χ_{itmd}) 290 onto the geometric model 270, followed by discarding all the accumulated potential reference edges (P_{edge}) 252. The updating process may continue until the wheelchair 70 approaches close enough to the table 61 when the system 300 starts to implement 3D motion planning. That is, the system 300 is configured not to use 3D motion planning in moving to the first intermediate dock pose (χ_{itmd}) 290.

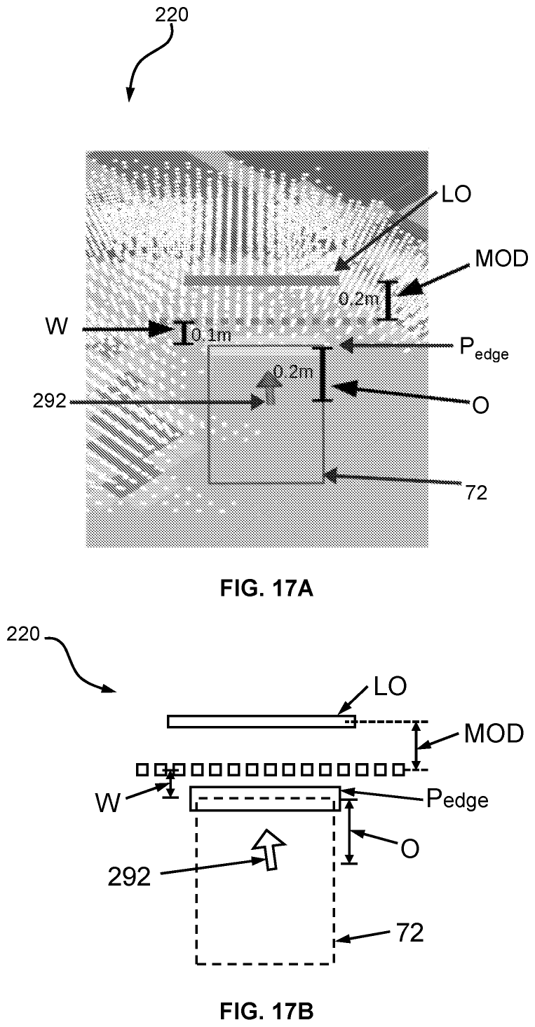

In some embodiments, when one or more articles or obstacles are partially occluding the object 60 (e.g., the table 61) when viewed from the wheelchair (also referred to as the wheelchair approach side), the intermediate dock pose (χ_{itmd}) 290 determined using the convex hull may not lie outside the table 61. In such a situation there is a risk of inaccuracy in the determination of the subsequent dock pose (χ_{dock}) 292. In such cases, as illustrated in FIG. 17A, the wheelchair docking system 100 may iteratively update (e.g., step 180 of FIG. 1) the intermediate dock pose (χ_{itmd}) 290, by determining the first group of edges 230 or the edges 230 of the convex hull closest to the 3D point (Pᵤ) 222 with the latest spatio-temporal voxel layer of the 3D point cloud, and updating the intermediate dock pose (χ_{itmd}) 290 as the wheelchair 70 (represented here by the footprint 72) moves towards the table 60 until a point in time where the wheelchair 70 moves past the occluding object(s). In some embodiments, the updating of the intermediate dock pose (χ_{itmd}) 290 may be performed periodically, for example every 0.5 seconds, with the latest spatio-temporal voxel layer of the 3D point cloud. Reference may also be made to FIG. 17B which is a line drawing representation of FIG. 17A from which the 3D point cloud image has been omitted to avoid obfuscation.

### Motion Planning

Upon determination of the dock pose (χ_{dock}) 292, the wheelchair docking system 100 may begin motion planning in determining a path of motion for the wheelchair 70 and controllably moving the wheelchair 70 along the determined path of motion (step 175 of FIG. 1). Preferably, the system 300 is configured to implement a combination of 2D path planner and 3D motion planner. Preferably, the system 300 is configured to perform constant updating as the wheelchair moves towards the dock pose, based on the lighter computational load of the 2D path planner. Preferably, the system 300 is configured to use the 3D motion planner during the final docking action where a greater degree of accuracy is preferred.

When the wheelchair 70 is relatively far apart from the table 61, for example, more than about 1.0 m radial distance from the dock pose (χ_{dock}) 292, a 2D path planner may be employed for determining a path of motion for the wheelchair 70 from a current position to the dock pose (χ_{dock}) 292. In some embodiments, the wheelchair docking system 100 may include a 2D path planner such as a ROS navigation stack, move base with Navfn as global planner and TEB as the local planner. In some embodiments, the 2D path planner may include a costmap (2D costmap).

Typically, 2D path planners require a minimum obstacle distance (MOD) for obstacle avoidance that will stop the wheelchair 70 too far (such as 0.2 m) for the user to comfortable use the table 61. Disregarding the table 61 from the local costmap may not be a feasible option as the 2D path planner may then plan a path through the table 60 leading to collision. Referring to FIG. 17A, the present method 100 includes, using the 2D path planner with a part or a portion of the table 61 removed from the local costmap (2D costmap). In some embodiments, a width (W) of this removed portion of the table 61 removed corresponds to a width/depth of the wheelchair 70 moving under the table top. In some embodiments, the width (W) of the removed portion of the table 61 may be determined based on the shape of the wheelchair 70, such that part of the wheelchair 70 may go under the table top. As an example, the width (W) of the removed portion of the table 61 may be 0.1 m, such that the wheelchair 70 may go under the table top by 0.1 m. This alleviates the problem that may arise when the 2D path planner fails to find a path to the dock pose (χ_{dock}) 292 because the dock pose (χ_{dock}) 292 is too close to the table 61 while balancing the need for the user to sit close enough to use the table 61 comfortably.

According to an embodiment of the present method 100, the system 300 is configured to first remove the whole table top (visible surface 64) from the costmap. This may be done by removing all the points above a certain threshold height from the 3D point cloud 220, for example 0.5 m, before projecting the 3D point cloud 220 to the local costmap. A line obstacle (LO) is positioned or placed in front of the dock pose (χ_{dock}) 292 perpendicular to an orientation of the line obstacle (LO). To allow the wheelchair 70 to go 0.1 m under the table 60, the line obstacle (LO) is defined at 0.5 m distance in a case where the dock pose (χ_{dock}) 292 is at an offset (O) of 0.2 m from the estimated table edge (P_{edge}) and where the minimum obstacle distance (MOD) is set as 0.2 m. This allows the 2D planner to plan a path to the dock pose (χ_{dock}) 292 in which the wheelchair 70 can be taken in up to 0.1m under the table top.

Further to providing the 2D planner to plan a path to the dock pose (χ_{dock}) 292, the system 300 is configured to deploy a 3D planner when the wheelchair reaches a position within 1.0 m radial distance from the dock pose (χ_{dock}) 292. In some embodiments, the 3D planner may include MoveIt with RRT* as a global planner and a PID controller as a local planner for planning a path to the dock pose (χ_{dock}) 292 based on a generated 3D OctoMap and a 3D model of the wheelchair 70. The path may be constrained such that the wheelchair 70 does not move out of a cuboid, as an example, with dimension of about 4.0 m×4.0 m×2.0 m around a current position of the wheelchair 70. This ensures that the path planned is not outside the 3D OctoMap. The system 300 may be optionally configured to stop the updating of the dock pose (χ_{dock}) 292 once the 3D motion planning begins, such that the 3D motion planning is not reiterated.

In some embodiments, the motor 330 may be controllably operated by the controller 310 such that the adjustable camera 326 is rotated at every 0.5 seconds to allow the adjustable camera 326 to face a point selected by the user and keep at least a part of the table 61 within the camera view. The rotation of the adjustable camera 326 may be limited to about 20 degrees in either direction to prevent a lag between the updating of the camera pose and the actual rotation. Correspondingly, the system 300 may be configured to disregard all the points in the 3D point cloud that are outside of the +20 degrees will not be used for the spatio-temporal voxel layer and/or the OctoMap.

Referring again to FIG. 1, the present method 100 may also be described as including a conversion of a user-selected 2D point on a 2D image of a scene into a 3D point of a 3D point cloud of the scene, wherein the user-selected 2D point is adjacent to a docking station in the 2D image (110). The method 100 further includes determining a first group of edges from the 3D point cloud, wherein the first group of edges surrounds the 3D point (120). The method includes determining an intermediate dock pose spaced apart from an approximated reference edge of the docking station, wherein the approximated reference edge is one selected from the first group of edges closest to the 3D point (130). The method further includes determining a second group of edges from the 3D point cloud based on the intermediate dock pose, wherein the intermediate dock pose faces the second group of edges (140). The method 100 includes determining at least one potential reference edges based on a plurality of random points of the 3D point cloud, wherein the second group of edges surrounds the plurality of random points (150). The method 100 includes fitting the at least one potential reference edges with a docketing station model (160). The method 100 includes determining a vehicle dock pose by projecting the intermediate dock pose onto the docking station model to form a projection and adding an offset to the projection (170). In some embodiments, the method 100 further comprises iteratively updating the vehicle dock pose based on an updated 3D point cloud. The method may also include iteratively updating the intermediate dock pose based on an updated 3D point cloud. In some embodiments, the method further comprises iteratively updating (180) the intermediate dock pose based on an updated 3D point cloud. The method may also include iteratively fitting (190) the at least one potential reference edges with the docketing station model based on an updated 3D point cloud.

Alternatively, the method may be described as follows:

In one aspect, the method 100 includes: converting a user-selected 2D point (step 110) in a two-dimensional (2D) image of a scene into a three-dimensional (3D) point in a 3D point cloud of the scene. The method 100 includes determining a first group of edges (convex hull) from the 3D point cloud based on the 3D point (step 120), in which the first group of edges includes an approximated reference edge of the object. The method 100 includes defining an intermediate dock pose (step 130) spaced apart from the approximated reference edge. The method 100 includes determining a second group of edges (concave hull) from the 3D point cloud (step 140), in which the second group of edges includes at least one potential reference edge. The at least one potential reference edge is based on a plurality of intersections between the second group of edges and respective projection lines extending between respective ones of a plurality of random points of the 3D point cloud and the intermediate dock pose. The method 100 includes determining a dock pose (step 170) based on one of the at least one potential reference edge, and moving the wheelchair towards the dock pose.

In another aspect, the system 300 includes: a wheelchair 70 having motorized wheels 330; an adjustable camera 326 coupled to the wheelchair 70 and adjustable to obtain a view of the scene as viewed from the wheelchair 70; a user interface 350 configured to receive a user-selected 2D point as an input from a user; and a controller 310. The controller 310 is configured to: convert the user-selected 2D point in a two-dimensional (2D) image of the scene into a three-dimensional (3D) point in a 3D point cloud of the scene (step 110); determine a first group of edges from the 3D point cloud based on the 3D point (step 120), the first group of edges including an approximated reference edge of the object; define an intermediate dock pose (step 130) spaced apart from the approximated reference edge; determine a second group of edges (step 140) from the 3D point cloud, the second group of edges including at least one potential reference edge, the at least one potential reference edge being based on a plurality of intersections between the second group of edges and respective projection lines extending between respective ones of a plurality of random points of the 3D point cloud and the intermediate dock pose; determine a dock pose (step 170) based on one of the at least one potential reference edge; and control the motorized wheels to move the wheelchair towards the dock pose.

The user interface 350 may be configured to present the 2D image as a RGB (Red Green Blue) image based on the view of the scene obtained by the adjustable camera 326. The 2D image may be made up of a plurality of pixels, with any of the plurality of pixels being available for selection as the user-selected 2D point. The controller 310 is configured to receive the user-selected 2D point as user input before obtaining the 3D point cloud, in which the 3D point cloud being generated about the 3D point. Advantageously, the system 300 is operable when the 2D image includes a partial image of the object 60.

### Experiments & Results

Various experiments were designed and carried out to evaluate the proposed system 300 and method 100 of wheelchair docking to evaluate the effectiveness to handle partially visible tables and sparse point clouds. A baseline experiment was conducted using a conventional method and used for comparison.

### Baseline

For the baseline, the conventional method involves first autonomously detecting table docking locations by trying to fit a table plane to the scene point cloud and then showing the user the detected table docking locations in the form of a 3D point cloud image. The user is therefore only allowed to select one of the detected docking locations. It was found that the user had difficulty choosing from the detected docking locations, especially because the untrained user cannot clearly identify the table in the point cloud. To aid the user, in the experiments to establish a baseline, the point cloud of the scene is transformed to a frame behind the wheelchair. An image of the wheelchair is added to the point cloud image to help the user localize the table in the point cloud. In a first experiment, the wheelchair position is fixed as control over the region of the table visible to the camera is desired. For the user study experiments, the user may move the wheelchair to get a better view of the table if the user is not satisfied with the displayed docking positions before selecting a docking position.

After the docking position is selected by the user, the wheelchair was moved to that docking position. For a fair comparison, a same planner for the baseline was used.

### Effect of Table Visibility and Point Cloud Density

This section describes the experiments conducted to test the effectiveness of the proposed system 300 and method 100 to handle partially visible objects 60 or partially visible docking positions.

Experiments were set out to determine if the method 100 of wheelchair docking as disclosed herein is able to perform better when the table visibility decreases as compared to the baseline approach. Another aim of the experiments is to determine if an initial vehicle dock pose refined over time as the wheelchair moves towards the table results in a final dock pose that improves over an initial dock pose.

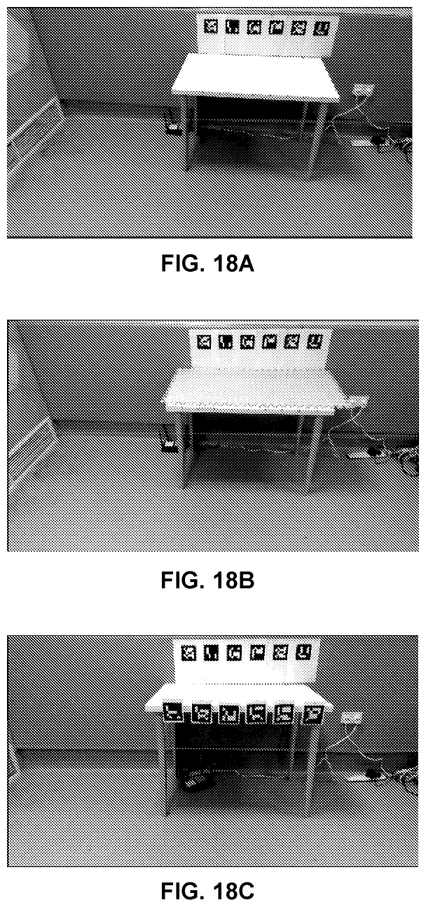

For the experiments, a glossy white table (table with a highly reflective table top surface) was placed close to a wall to provide a relatively sparse point cloud under normal lighting, as shown in FIG. 18A. No obstructions were present around the table to block its visibility. For conducting these experiments, it is required to extract the ground truth table dock pose for comparison with the dock pose identified by the proposed method and that of the baseline. For this purpose, twelve Aruco markers were used as shown in FIG. 18C. Six of the Aruco markers are attached to the wall adjacent to the table. The other six of the Aruco markers are attached to the table edges. In a calibration stage, the transformation between each of the markers on the wall and each of the markers on the table edge are estimated. During an experiment stage, only the Aruco markers attached to the wall are present. By using the detected markers and the corresponding estimated transformations, the table edge marker positions (ground truth dock poses) are obtained.

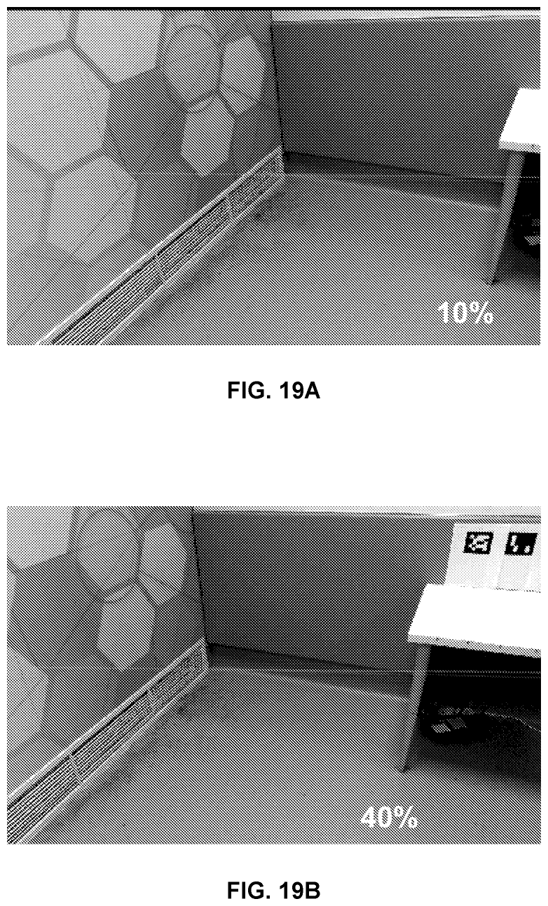

In the experiments, the wheelchair starts from a fixed position (1.2m away from the table). By rotating the wheelchair at this position, the region of the table visible to the camera was controlled. The table visibility was varied from 10% to 100% in increments of 10%. FIGS. 19A and 19B show exemplary cases of table visibility at 10% and 40% respectively. For each level of visibility, the user initiates docking operation using the proposed method and using the baseline method. The dock poses generated by both methods are compared with the ground truth dock pose to determine the pose with the minimum position error and the corresponding orientation error.

Root mean squared error (RMSE) was used for computing the position error. For the orientation error, the corresponding yaw angle difference in degrees was used. For the proposed method 100, a smaller error was noted for both the intermediate dock pose and the final dock pose. In comparison, the baseline produced an array of docking poses based on the identified table and the pose with least error is noted.

The table docking trial is considered successful if the wheelchair was able to dock to the table without any errors. For each level of visibility, trials were conducted until two successful trials were recorded. To study the effect of the 3D point cloud density, the same experiment was run under two conditions. Firstly, the white table was used as such since it provided a relatively sparse 3D point cloud. Secondly, the table top was covered with non-reflective mats as shown in FIG. 18B so that a dense 3D point cloud could be obtained. The results of experiments are tabulated in Tables 2 and 3.

TABLE 2
Minimum position and orientation error for dock poses estimates by proposed
docking method and baseline method when a dense 3D point cloud is available

| | Proposed Table docking framework | | | | Baseline Method | |
|---|---|---|---|---|---|---|
| | Intermediate docking pose | | Final docking pose | | Baseline docking pose | |
| Table | Position | Orientation | Position | Orientation | Position | Orientation |
| Visibility | error | error | error | error | error | error |
| 100 | 0.2163 | 4.1466 | 0.0949 | 7.4746 | 0.0015 | 9.5793 |
| 100 | 0.0693 | −6.4823 | 0.0656 | −7.1354 | 0.0849 | 8.7929 |
| 90 | 0.1955 | 7.7915 | 0.0720 | −0.7330 | 0.0395 | 10.5699 |
| 90 | 0.1904 | −1.3693 | 0.1112 | 3.4769 | 0.0152 | −3.4032 |
| 80 | 0.2226 | 13.2907 | 0.1124 | 5.5523 | 0.0550 | −13.5076 |
| 80 | 0.2136 | 2.2116 | 0.1253 | 1.0768 | 0.0450 | −18.4335 |
| 70 | 0.1048 | −27.2990 | 0.1314 | −10.9992 | 0.0183 | −13.2718 |
| 70 | 0.1372 | 4.9438 | 0.1283 | −2.5464 | 0.0414 | 13.2288 |
| 60 | 0.1544 | 2.7536 | 0.1230 | 0.8319 | 0.0348 | −21.6235 |
| 60 | 0.1475 | −2.2493 | 0.1465 | −3.4916 | 0.0433 | −20.69 |
| 50 | 0.1458 | −6.9201 | 0.1257 | −9.4638 | 0.0285 | −21.7459 |
| 50 | 0.1465 | −1.5500 | 0.1492 | −1.7577 | 0.0140 | −25.4116 |
| 40 | 0.2190 | −6.5272 | 0.2123 | −18.3202 | 0.0242 | −23.8145 |
| 40 | 0.2190 | 2.3252 | 0.1723 | −6.9116 | 0.0513 | −52.2831 |
| 30 | 0.4003 | 12.4017 | 0.1203 | 5.1966 | 0.01872 | −26.5287 |
| 30 | 0.2337 | 6.5301 | 0.2062 | 1.6942 | — | — |
| 20 | 0.3228 | −17.3280 | 0.1813 | −17.3280 | — | — |
| 20 | 0.2315 | 0.0177 | 0.2315 | 0.0177 | — | — |
| 10 | 0.4030 | 27.9565 | 0.1781 | −21.8072 | — | — |
| 10 | 0.2467 | −78.5578 | 0.1934 | −5.6605 | — | — |

TABLE 3
Minimum position and orientation error for dock poses estimates by proposed
docking method and baseline method when a sparse 3D point cloud is available

| | Proposed Table docking framework | | | | Baseline Method | |
|---|---|---|---|---|---|---|
| | Intermediate docking pose | | Final docking pose | | Baseline docking pose | |
| Table | Position | Orientation | Position | Orientation | Position | Orientation |
| Visibility | error | error | error | error | error | error |
| 100 | 0.1977 | 16.7555 | 0.0969 | −2.5796 | 0.1292 | −6.3599 |
| 100 | 0.2333 | 1.2650 | 0.1143 | 0.8033 | 0.1239 | −8.7790 |
| 90 | 0.2020 | 6.0354 | 0.0925 | −1.3270 | 0.0994 | −10.0998 |
| 90 | 0.0655 | −14.5845 | 0.0273 | 1.9182 | 0.0282 | −13.2870 |
| 80 | 0.1516 | −38.9833 | 0.1029 | −4.8969 | 0.0224 | −13.8218 |
| 80 | 0.1040 | 3.8549 | 0.1006 | 2.2284 | 0.0134 | −14.1646 |
| 70 | 0.2789 | −26.2939 | 0.1412 | −3.0372 | 0.0875 | 9.8954 |
| 70 | 0.0984 | −21.1032 | 0.0739 | −5.2556 | 0.0982 | −15.6274 |
| 60 | 0.2174 | 2.6175 | 0.1658 | −1.6680 | 0.0446 | 24.9476 |
| 60 | 0.1757 | 0.1277 | 0.1748 | −8.6100 | 0.0896 | 34.1324 |
| 50 | 0.1743 | −0.9661 | 0.0969 | −5.9430 | 0.2217 | 42.7724 |
| 50 | 0.7401 | 30.9461 | 0.1060 | −9.9158 | 0.0294 | −27.0013 |
| 40 | 0.2323 | −24.9367 | 0.1529 | −6.9265 | — | — |
| 40 | 0.2047 | 6.7729 | 0.1582 | 9.6319 | — | — |
| 30 | 0.2068 | 1.8065 | 0.1446 | 13.7233 | — | — |
| 30 | 0.1994 | 1.2929 | 0.1287 | 15.8810 | — | — |
| 20 | 0.2383 | 4.5446 | 0.1144 | −18.1335 | — | — |
| 20 | 0.1744 | −21.4536 | 0.1890 | 0.3462 | — | — |
| 10 | 0.3112 | 27.5629 | 0.1305 | −13.9671 | — | — |
| 10 | 0.1633 | 4.4376 | 0.1633 | 4.4376 | — | — |

From Tables 1 and 2, it is evident that the present method 100 is able to handle partially visible tables with relative ease. For all levels of table visibility, the wheelchair was successfully docked to the table and with very low dock pose errors in terms of the position and the orientation. In comparison, the baseline method did not have a successful trial when there was less than 30% table visibility and less than 50% table visibility in the dense and sparse 3D point clouds respectively. Further, it is evident that the dock pose orientation error increased for the baseline method as the table visibility decreases. When a dense 3D point cloud was available, the maximum dock pose orientation error observed was 52.28 degrees and 21.80 degrees for the baseline and the present method 100 respectively. Similarly for a sparse 3D point cloud, the maximum orientation error observed was 42.77 degrees and 18.13 degrees for the baseline and the present method 100 respectively. The baseline method shows an orientation error of about 27 degrees when the table visibility was about 50%, while the present method 100 did not show an orientation error of about 27 degrees in the intermediate dock pose until table visibility dropped to about 10%. Even so, the orientation error of the corresponding final dock pose was only about 14%. To achieve an orientation error of only 14%, the conventional baseline method needs the table visibility to be at least 80%.

As shown in Tables 2 and 3, both the position error and the orientation error exhibit significant improvements between the intermediate and final dock pose in the proposed system 300 and method 100. This may be taken to indicate that the present system 300 and method 100 can achieve a satisfactory final dock pose.

The failed trials and respective causes were analyzed to get better insights about both methods. In total, 19 failed attempts at wheelchair docking was observed when using the proposed method 100. The proposed method 100 exhibits satisfactory performance in completing the docking task, and the failed attempts were attributable to the quality of the 3D point cloud generated and the reliability of the 3D motion planners used. In contrast, the baseline experiments had 45 failed attempts with most of the failures being related to the dock pose estimated. In a majority of the cases, the conventional baseline method was unable to generate a dock pose, identified dock poses with orientation errors of more than 90 degrees, or identified a dock pose on a wrong edge of the table (an edge that could not be reached by the wheelchair). In other cases, it was observed that a circular table was detected at a wrong location. In summary, the conventional baseline method was not able to complete the docking task even with high quality 3D point clouds and similar 3D motion planning. The failures of the conventional baseline method can also be attributed to a failure to handle a table that is only at most partially visible.

### Table Occlusion

In real scenarios, the table might be occluded by various articles and clutter, making it difficult to identify an appropriate table edge. As described in the foregoing, it has been experimentally verified that the proposed method 100 could remove one or more potential reference edges from consideration. In other words, the proposed method 100 is sufficiently robust to deal with a partially occluded table and/or a cluttered table top.

Experiments with and without Segmentation

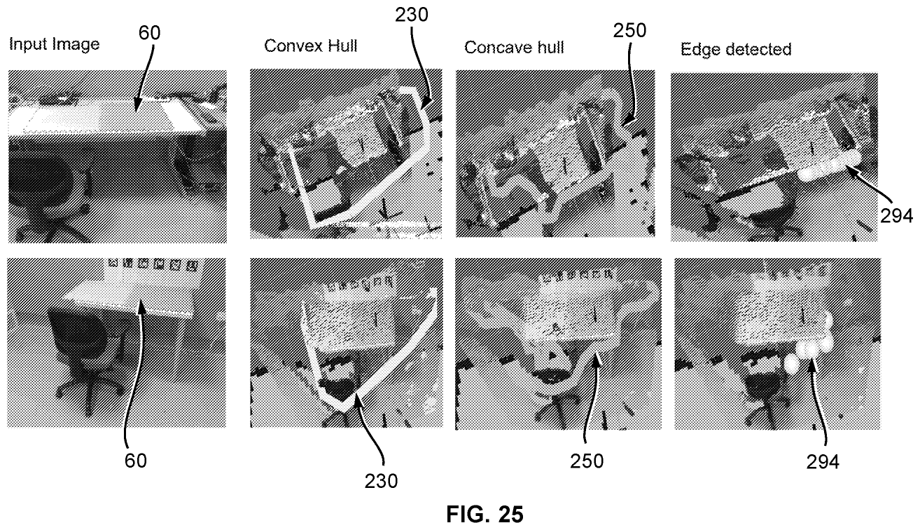

The proposed method 100 may optionally include an image segmentation step (e.g., step 115 of FIG. 1) to segment out table regions for better table edge estimation. FIGS. 24 and 25 illustrate the respective steps of the method 100 and the effect of segmentation on edge detection and dock pose determination. The experiments were conducted using two tables of different sizes (the upper row of images in FIGS. 24 and 25 show a relatively big table and the lower row of images in FIGS. 24 and 25 show a relatively small table) covered with non-reflective mats. Further, the table was intentionally at least partially occluded by placing a chair in front of it. In both cases, the first edges (or convex hull), the second edges (or concave hull), and the table edge were determined by the method 100. As shown in FIG. 25, when segmentation was not employed in the method 100, although the edge computed for the small table may be less precise and may include portions of the chair, the proposed method 100 can still compute a number of acceptable final dock poses. In the case for the big table, irrespective of whether segmentation was employed, the proposed method 100 was able to detect a satisfactory table edge and a satisfactory final dock pose. With segmentation, when the experiment was conducted using the smaller table, the proposed method 100 was able to segment out the chair. Although the concave hull may still include parts of the chair, probably due to noise, a satisfactory edge was computed after edge filtering. Advantageously, the present method may be implemented optionally with segmentation and edge filtering in situations where the point cloud is noisy, when the table edge is short or when the table is small.

Studies on the Threshold angle Θ_{edges}

As described above, in the process of estimating the table edge from the concave hull, edges that are not within the threshold angle Θ_{edges} of the intermediate dock pose χ_{itmd} were filtered out. To evaluate the effect of varying this threshold, experiments were conducted in which the proposed method 100 was employed with different threshold angles Θ_{edges}=25 degrees, 45 degrees, and 65 degrees, respectively. The same experimental setup as the one used in FIGS. 24 and 25 was used and tested with three different user-selected 2D points on the table, namely, (i) close to the chair, (ii) mid-point of the visible edge, and (iii) close to corner of the table. In the experiments, it was observed that varying the threshold angle does not affect the table edge detection nor computation of the dock pose. Although some sample points from chair or other corners of the table may be included, the proposed method is sufficiently robust such that most of the points are at the desired edge, i.e., the proposed method 100 was experimentally verified to be capable of identifying a good table edge and a practical final dock pose.

### User Experience Study

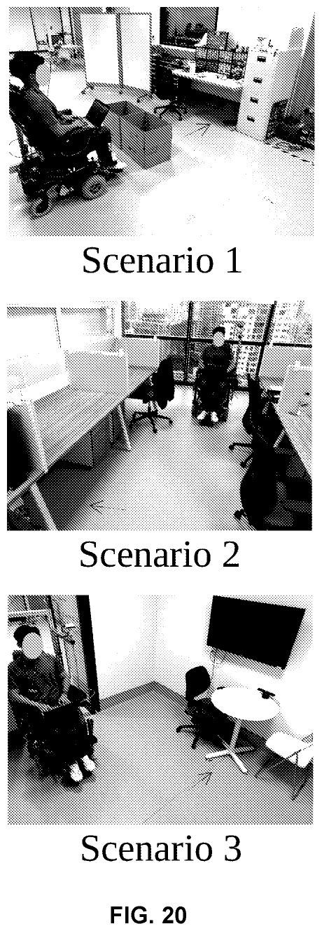

An experiment was designed and carried out to evaluate the proposed method 100 and system 300 from the perspective of user experience. A total of 16 volunteers participated in the experiment. The volunteers tested both the proposed system 300 and the conventional baseline system in three scenarios as shown in FIG. 20. The first scenario (Scenario One) mimicked a situation of docking at a table in a food court. The second scenario (Scenario Two) was intended to be similar to docking the wheelchair at a workstation in an office where the table is generally rectangular. The third scenario (Scenario Three) was intended to be similar to docking the wheelchair at a table in a small meeting room where the table is circular in shape.

The experiment set out to determine if users would find it easier to convey intended docking position by clicking on a 2D RGB image as compared to clicking on pre-computed docking poses. Another aspect of the experiment determines whether computation of dock pose using the 3D point cloud around the user's selected 2D point and updating the dock pose using additional point cloud data will result in fewer motion planning failures.

At the beginning of the experiment, each participant was asked to fill up an informed consent, as required by the Institutional Review Board (IRB) guidelines. Subsequently, a five-minutes familiarization session was conducted to acquaint the participant with the wheelchair control, as well as the docking process. Each participant was asked to perform the docking task in Scenario One, using both the conventional baseline method and the proposed method 100. After the familiarization session, the wheelchair was moved to a pre-defined start position as shown in FIG. 20. During each run of the scenarios, to avoid confounding due to order effects, the participant would perform the three tests—(i) dock to the table manually, (ii) dock to the table using the baseline system, and (iii) dock to the table using the proposed system 300—in a random order.

The following performance measures were recorded during each trial of the experiment:
(i) Time taken to complete the task. The task completion time is the summation of the time taken to convey the desired docking pose (Interaction time) tᵢ and time taken to reach the dock pose (Reaching time) tᵣ.
(ii) Number of failed trials. A trial is considered unsuccessful or failed if (a) the planner could not plan a path to the docking pose, or (b) the planner could plan a path but execution of the path could not be completed because a false collision with environment was detected due to noisy point cloud, or (c) e-stop was pressed by the user due to collision or anticipation of collision.
(iii) User workload and satisfaction. A questionnaire was administered at the end of each trial and the user rated workload according to the six scales of the NASA-task load index (TLX): mental workload, physical demand, temporal demand, as well as the perceived level of task performance by the participant, effort, and frustration. Two additional scales were included to rate user satisfaction with regard to the final dock pose and the time taken for docking. Each scale was rated on a 10-point Likert semantic differential scale, with 1 being total agreement and 10 being total disagreement with the statement.

TABLE 4
Questions to evaluate the baseline method
and the proposed method for docking.
Perceived Usefulness Questions

| | |
|---|---|
| Q1 | I am able to dock more quickly when using this algorithm. |
| Q2 | This algorithm improves my table docking performance. |
| Q3 | It is easier to dock to table using this algorithm. |
| Q4 | I find this algorithm useful. |

Perceived Ease-of-Use Questions

| | |
|---|---|
| Q5 | Learning to use this algorithm is easy for me. |
| Q6 | It is easy to get this algorithm to do what I want it to do. |
| Q7 | It is easy for me to become skillful at using this algorithm. |
| Q8 | I would find this algorithm easy to use. |

The questions in the questionnaire are shown in Table 4. Additionally, the following questions were asked to compare the overall preference of the systems:
1) Do you prefer manual table docking or autonomous table docking? Why?
2) Which of the autonomous table docking method do you prefer? Why?
3) Any other comments?

TABLE 5
Average Interaction Time and Reaching Time in Seconds

| | Scenario One | | Scenario Two | | Scenario Three | |
|---|---|---|---|---|---|---|
| System Type | tᵢ | tᵣ | tᵢ | tᵣ | tᵢ | tₚ |
| Present System | 12.813 | 95.917 | 10.241 | 73.883 | 21.629 | 52.208 |
| Baseline | 27.902 | 79.478 | 66.139 | 75.031 | 50.727 | 52.236 |
| System | | | | | | |

TABLE 6
Percentage of Failures

| System Type | Scenario One | Scenario Two | Scenario Three |
|---|---|---|---|
| The present system | 37.5 | 18.75 | 12.5 |
| The baseline system | 43.75 | 43.75 | 25.0 |

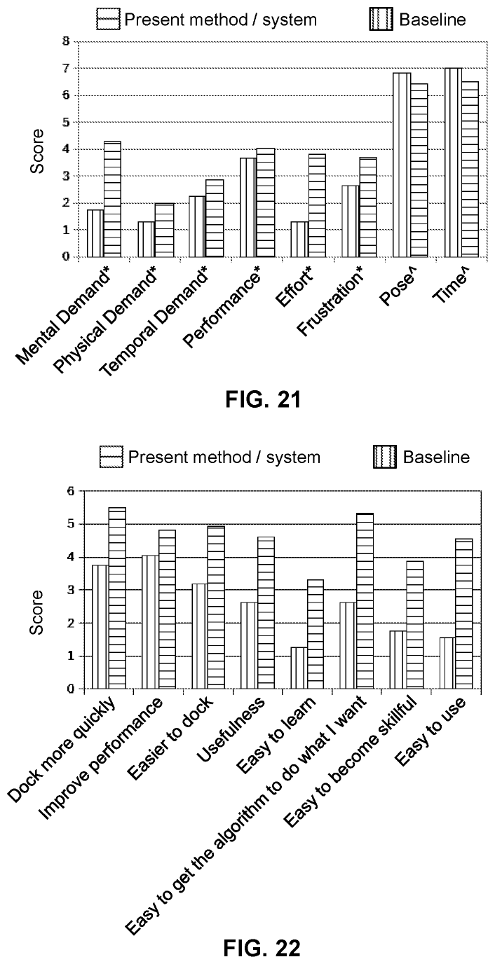

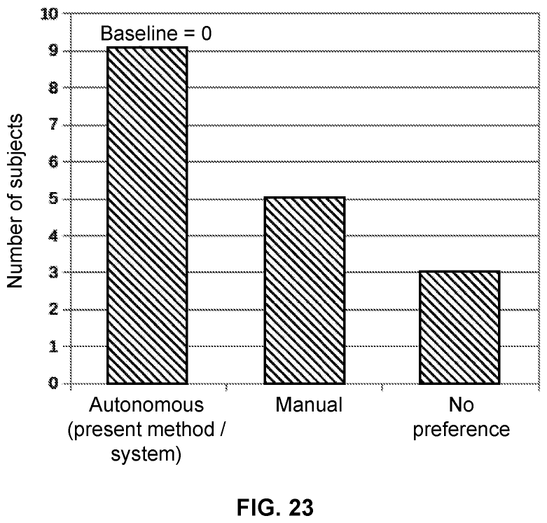

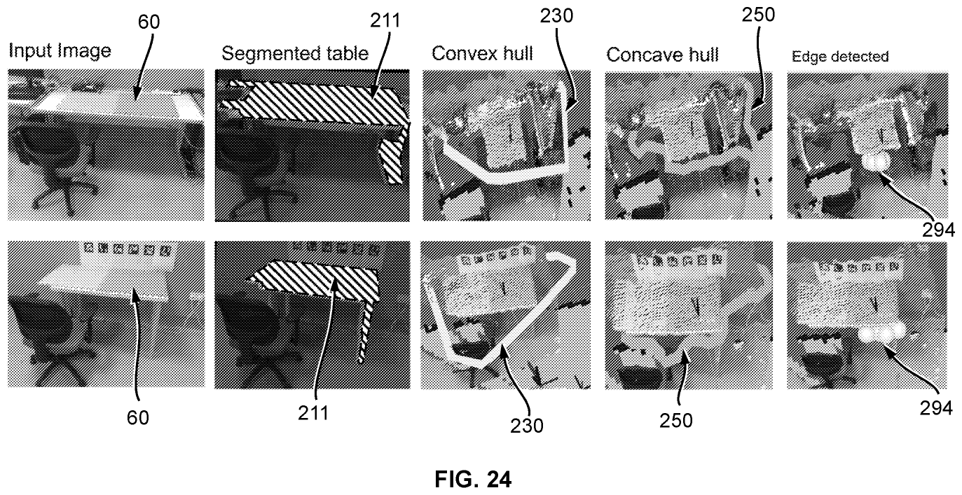

Table 5 shows the Average Interaction time tᵢ for all the 16 trials in each scenario and the average of Reaching Time tᵣ for the successful trials in each scenario. Table 6 shows the percentage of trials that failed for the present system 300 and for the baseline system. Results of user questionnaire are plotted in FIGS. 21, 22, and 23.

As shown in Table 5, the Interaction Time tᵢ is significantly lower for the proposed system 300 as compared to the conventional baseline system. ANOVA (analysis of variance) analysis of Interaction Time shows that the difference is statistically significant (p<0.05; 0.001, 6.8E-05 and 0.002 for Scenarios One, Two, and Three, respectively). There is no significant difference in the average Reaching Time tᵣ for Scenarios Two and Three, while for Scenario One, Reaching Time tᵣ for our system is higher. However, given very high variance in Reaching Time tᵣ due to factors like replanning done by 3D motion planner, ANOVA analysis shows that this difference is not statistically significant (p>0.1; 0.22, 0.87 and 1.00 for Scenarios One, Two, and Three, respectively). Specifically for Scenario One, it was observed that due to the material of the table, wheelchair docking pose is computed slightly closer to the table, which increases planning time in many trials due to replanning. Thus, it may be understood that by using the proposed system 300, users could complete the docking task faster by conveying their intention more quickly. To verify whether this also translates to user satisfaction, reference may be taken to results of the questionnaire.

From FIGS. 21 and 22, it may be observed that the proposed system received significantly better scores for the amount of effort required for docking (1.29 vs 3.69) and for ease of use (1.56 vs 4.56). ANOVA analysis shows that the difference is statistically significant (p<0.05; 8.98E-09 and 0.000003 for the amount of effort required and ease of use, respectively). Overall, from FIGS. 21 and 22, it is evident that the proposed system 300 received a better score for all the questions and that the improvement is considerably great in terms of mental demand, effort, and ease of use. Therefore, it may be understood that users find it easier to convey their desired docking position using the present system 300 as compared to the conventional baseline system. As observed for the baseline system, it took longer to convey the desired docking position because the conventional system is not operable in multiple instances, e.g., where the table is only partially visible or where the viewing angle is not optimum. When the baseline system fails to find any docking pose, the user has to adjust the wheelchair position to make the algorithm detect the docking poses. Although the viewing angle may be improved if the user navigates to different positions, this can be frustrating and difficult for users who are frail or have upper body disabilities than make manual re-orientation of the wheelchair difficult. This problem is more pronounced when the table is at the side of the wheelchair (as in Scenario Two). The improvement provided by the proposed system 300 over the baseline system is most evident in that Scenario in terms of both the task completion time (Table 5) and user evaluation.

As shown in Table 6, the percentage of failure cases is much lower for the proposed system 300 as compared to the baseline system. In Scenario Two, the difference is especially significant. This is despite the user taking significantly more time to choose the docking position for the baseline system and despite the baseline system having an advantage in dock pose generation (the user can see the docking positions and adjust the wheelchair until a good docking position is available).

This suggests that the baseline system does not take into account the user's intention or preferences before computing docking locations and that the baseline system tries to compute the table top plane by finding the largest plane at a certain height in the point cloud. This results in inaccurate docking locations especially when the table is only partially visible or there are objects around (as in the case of Scenario Two). Noise in 3D point cloud when the wheelchair is far from the table also affects the docking positions computed. Users tried to overcome these shortcomings by moving the wheelchair a bit before selecting the docking location. However, from the failure rates, it was observed that the docking position selected is still not very good and that failures still occur too often.

On the other hand, the proposed system 300 makes use of one click from the user and looks at the point cloud only around the clicked point (selected point). This was surprisingly found to be particularly helpful in cases where table is only partially visible. The continuous update of the dock pose helps in dealing with occlusions and noisy point cloud when the wheelchair was far from the table. The overall pose satisfaction rating (6.81) was also higher for the proposed system as compared to baseline (6.44) (See FIG. 21).

Looking at the overall survey done at the end of the trial (See FIG. 22), all the users who chose an autonomous system over a fully manual system preferred to use the proposed system 300 instead of the baseline system. Compared to the baseline system, all the users found the proposed system 300 to be easier to use. Users also indicated that the final dock pose was more aligned to their desired pose when using the proposed system 300.

As described, the proposed system 300 and method 100 have been experimentally shown to be effective even when the table or the object is no more than partially visible or when the point clouds obtainable were fairly sparse. The user experience study conducted to evaluate the proposed wheelchair docking framework in realistic scenarios also score better in terms of users' preferences when compared against conventional methods.

In practical terms, this means that the present system 300 and the present method 100 can provide the user with greater flexibility and greater confidence when new situations are encountered. It also means that the user can more quickly and successfully perform docking of the wheelchair to new places or new objects.

1. A method of docking a wheelchair relative to an object, the method comprising:
converting a user-selected 2D point in a two-dimensional (2D) image of a scene into a three-dimensional (3D) point in a 3D point cloud of the scene;
determining a first group of edges from the 3D point cloud based on the 3D point, the first group of edges including an approximated reference edge of the object;
defining an intermediate dock pose spaced apart from the approximated reference edge by a spacing;
determining a second group of edges from the 3D point cloud, the second group of edges including at least one potential reference edge, the at least one potential reference edge being based on a plurality of intersections between the second group of edges and respective projection lines between a plurality of random points of the 3D point cloud from within the second group of edges and the intermediate dock pose;
determining a dock pose based on one of the at least one potential reference edge; and
moving the wheelchair towards the dock pose.

2. The method as recited in claim 1, comprising:
presenting the 2D image via a user interface as an RGB (Red Green Blue) image as viewed from the wheelchair, the 2D image being made up of a plurality of pixels, any of the plurality of pixels being available for selection as the user-selected 2D point; and
receiving the user-selected 2D-point as user input before obtaining the 3D point cloud, wherein the 3D point cloud is generated about the 3D point.

3. The method as recited in claim 1, wherein the 2D image comprises a partial image of the object.

4. The method as recited in claim 1, wherein the determining the dock pose comprises:
fitting the at least one potential reference edge with a geometric model of the object;
projecting the intermediate dock pose onto the geometric model to form a projection; and
adding an offset to the projection, such that the dock pose is spaced apart from the object by at least the offset.

5. The method as recited in claim 1, further comprising: determining the dock pose from a plurality of search poses responsive to a sum of cost within a footprint of the wheelchair exceeding a threshold.

6. The method as recited in claim 1, further comprising: determining a path of motion for the wheelchair from a current position to the dock pose via a 2D costmap.

7. The method as recited in claim 6, further comprising: removing a portion of the object from the 2D costmap, wherein a width of the portion of the object corresponds to a width of the wheelchair moving under the object.

8. The method as recited in claim 1, further comprising: iteratively updating the 3D point cloud based on a plurality of 2D images acquired at various time instants concurrently with the moving of the wheelchair.

9. The method as recited in claim 8, further comprising: iteratively updating the intermediate dock pose in response to the updating of the 3D point cloud.

10. The method as recited in claim 8, further comprising: iteratively fitting the at least one potential reference edge with the geometric model based on an updated 3D point cloud.

11. The method as recited in claim 1, further comprising:
determining a respective perpendicular pose for each of the at least one potential reference edge; and
selecting one of the at least one potential reference edge having a corresponding perpendicular pose within a threshold angle relative to the intermediate dock pose.

12. The method as recited in claim 11, wherein the threshold angle is one selected from a range from 25 degrees to 65 degrees, and wherein the predetermined range of height values is from 0.75 m to 1.2 m.

13. The method as recited in claim 1, further comprising: determining the first group of edges based on a convex hull of a first group of points from the 3D point cloud, wherein the first group of points are within a predetermined range of height values.

14. (canceled)

15. The method as recited in claim 1, further comprising: determining the second group of edges based on a concave hull of a second group of points of the 3D point cloud, wherein the second group of points are within a sampled region, wherein the intermediate dock pose faces the sampled region.

16. The method as recited in claim 1, further comprising: determining the 3D point cloud based on a spatio-temporal voxel layer accumulating a plurality of 3D points from multiple time instants.

17. The method as recited in claim 1, further comprising: segmenting the 2D image to obtain a segmented 2D image; and filtering the 3D point cloud to retain a plurality of 3D points corresponding to the object based on the segmented 2D image.

18. The method as recited in claim 1, wherein converting the user-selected 2D point into the three-dimensional (3D) point comprises determining the 3D point based on an intersection between a de-projection line and the 3D point cloud.

19. (canceled)

20. A system for wheelchair docking relative to an object, the system comprising:
a wheelchair having motorized wheels;
an adjustable camera coupled to the wheelchair and adjustable to obtain a view of the scene as viewed from the wheelchair;
a user interface configured to receive a user-selected 2D point as an input from a user; and
a controller coupled to the motorized wheels, and the adjustable camera, and the user interface, the controller being configured to:
convert the user-selected 2D point in a two-dimensional (2D) image of the scene into a three-dimensional (3D) point to which wheelchair can dock to;
determine a first group of edges from the 3D point cloud based on the 3D point, the first group of edges including an approximated reference edge of the object;
define an intermediate dock pose spaced apart from the approximated reference edge by a spacing;
determine a second group of edges from the 3D point cloud, the second group of edges including at least one potential reference edge, the at least one potential reference edge being based on a plurality of intersections between the second group of edges and respective projection lines between a plurality of random points of the 3D point cloud from within the second group of edges and the intermediate dock pose;
determine a dock pose based on one of the at least one potential reference edge; and
control the motorized wheels to move the wheelchair towards the dock pose.

21. The system as recited in claim 20, wherein the user interface is configured to present the 2D image as a RGB (Red Green Blue) image based on the view of the scene obtained by the adjustable camera, the 2D image being made up of a plurality of pixels, any of the plurality of pixels being available for selection as the user-selected 2D point; and wherein the controller is configured to receive the user-selected 2D point as user input before obtaining the 3D point cloud, the 3D point cloud being generated about the 3D point.

22. The system as recited in claim 20, wherein the 2D image comprises a partial image of the object.
